(19) United States
(12) Patent Application Publication
(10) Pub. No.: US 2014/0278121 A1
(43) Pub. Date: Sep. 18, 2014

(54) SYSTEMS AND METHODS FOR NETWORK-BASED CALCULATION AND REPORTING OF METABOLIC RISK

(71) Applicant: Robust for Life, Inc., (US)

(72) Inventors: John Armato, Manhattan Beach, CA (US); Ronald Ruby, Manhattan Beach, CA (US)

(73) Assignee: Robust for Life, Inc., Manhattan Beach, CA (US)

(21) Appl. No.: 13/800,730

(22) Filed: Mar. 13, 2013

(51) Int. Cl. G06F 19/00

(52) U.S. Cl. CPC G06F 19/322
USPC 702/19

(57) ABSTRACT

Systems and methods are provided for generating metabolic risk reports using a Beta Cell Responsiveness Score. A model for calculation of a Beta Cell Responsiveness Score is generated using a sample population. The Beta Cell Responsiveness Score may measure the appropriateness of an individual's beta cell insulin production in light of the individual's insulin resistance in such a way that it is understandable and clinically relevant. This may increase individuals' compliance with treatment recommendations and allow clinicians to more accurately assess where an individual's metabolic function lies along the spectrum of normal to pre-diabetic to diabetic.

### FIELD

The present invention relates to the field of preventative health care, more specifically to the evaluation of metabolic function to identify at-risk patients and enhance patient understanding and self-management.

### BACKGROUND

In various embodiments a method of determining the appropriateness of a beta cell response, methods of reporting metabolic function, including beta cell response and methods of modifying cardiovascular risk stratification based on metabolic indicators are provided.

Type-2 diabetes is now epidemic. In the U.S., there was a 61% increase in incidence between 1990 and 2001. There are currently 1.5 million new cases diagnosed per year, and the prevalence in 2005 was almost 21 million patients. The epidemic affects developed and developing countries alike, and the worldwide prevalence of diabetes is projected to increase dramatically by 2025. The increase in type-2 diabetes is related to lifestyle changes that have resulted in obesity and decreased physical activity levels. These environmental changes, superimposed on genetic predisposition, lead to increased insulin resistance, which, in concert with progressive B-cell (beta cell) failure, results in rising glycemia in the non-diabetic range. Further reduction in insulin secretion over time may result in increasing glycemia and the development of diabetes, which in turn is associated with the development of microvascular and cardiovascular complications. In addition to the risk for diabetes, insulin resistance and impaired insulin secretion are accompanied by a host of major cardiovascular disease (CVD) risk factors including hypertension and dyslipidemia.

Each year close to 1.4 million people in the United States experience a heart attack and in excess of 500,000 die from it. Unfortunately, 50 to 70 percent of those individuals who died from a heart attack were not aware of their risk. Atherosclerotic cardiovascular disease and coronary heart disease accounts for the majority of this toll. Despite major advances in treatment of coronary heart disease patients, a large number of victims of the disease who are apparently healthy die suddenly without prior symptoms. Conventional screening and diagnostic methods are insufficient to identify the victims before the event occurs.

For many years, preventative medicine has focused on not only identifying patients at risk for development of diabetes and cardiovascular disorders but also educating them so that they may participate in the reversal or mitigation of their pathology to avoid morbidity and mortality. This has often met with only indifferent success. Efforts meet with problems in communicating the medical issues to patients. Furthermore, compliance with suggested lifestyle modifications and therapeutic regimens is often poor.

### SUMMARY

In various embodiments a method of determining the appropriateness of a beta cell response, methods of reporting metabolic function, including beta cell response and methods of modifying cardiovascular risk stratification based on metabolic indicators are provided. The methods herein described identify asymptomatic patients at risk for diabetes, heart attack, stroke, and other consequences of insulin resistance and beta cell dysfunction. Identifying “at risk” patients allows the development of personalized preventive health strategies based upon individualized assessments to improve preventive efforts. In addition to identification, various methods described below provide a means of communicating a level of risk to individuals such that they understand the implications of their health state, which may in turn improve compliance with preventative regimens and decrease the rate of development of diabetes, heart attack, stroke, and other adverse consequences.

Various embodiments described below provide a method or system to effectively and understandably communicate laboratory and imaging results to patients so that they can understand their current medical conditions and the potential for developing more serious ones. Some embodiments provide a method or system to develop a personalized preventative health strategy for patients based on their individualized assessments to improve preventative efforts. This may involve identifying at-risk individuals who are not identified using conventional assessment tools. This may also involve generating reports for patients, which transform their laboratory, demographic, and radiologic results to produce information in a format which is comprehensive and understandable. These reports may communicate a personalized preventative health strategy. Furthermore, the reports may improve patient compliance through updates which calculate changes in various risk factors or improvements in particular measurements over time when more data is provided by the health care provider or patient and otherwise incentivize patients to continue with their treatment plans.

### BRIEF DESCRIPTION OF THE DRAWINGS

FIG. 1 is a network diagram schematically illustrating an example of a report server system.

FIGS. 2A and 2B illustrate embodiments of computing environments that can implement a metabolic profile reporting system.

FIG. 3 is a flow diagram depicting an illustrative process for providing a Beta Cell Responsiveness Report.

FIG. 4 is a flow diagram depicting an illustrative process for generating a Beta Cell Responsiveness Score and Diabetic Risk Category for a patient.

FIG. 5 is a flow diagram depicting an illustrative process for generating a Beta Cell Responsiveness Score (BCRS).

FIG. 6 is a flow diagram depicting an illustrative clinical model building process for generating a BCRS calculation.

### DETAILED DESCRIPTION

### A. Metabolic and Cardiovascular Pathology

Diabetes is a disease in which the normal regulation of blood sugars by the production and utilization of insulin no longer takes place. This can occur by a failure to produce insulin, as in Type I Insulin Dependent Diabetes. Alternatively, as in Type II Non-Insulin Dependent Diabetes, the tissues of the body become increasingly resistant to insulin, such that it requires increasing amounts to maintain normal blood sugars. Over time, this increased demand may lead to failure of the cells which produce insulin.

Insulin is produced in the pancreas by beta cells. Insulin resistance may manifest in the liver, where insulin regulates the hepatic production of glucose. If insufficient insulin is present, the liver continues producing and releasing glucose into the bloodstream, elevating serum glucose levels. In the skeletal muscles, insulin resistance can cause diminished transport from the blood into the muscle tissue, thereby failing to lower the blood glucose. beta cells may increase their production of insulin to offset such resistance, but, over time, may no longer be able to compensate, and may lose their ability to function and/or die. During this period when resistance is elevated and/or beta cell response is diminishing, patients are considered to be in a pre-diabetic state. By the time a patient has become diabetic by standard diagnostic guidelines, it is believed that they have already lost up to 80% of their beta cell function. Therefore, in order to minimize loss of beta cell function, it is extremely important to address patients as early as possible in the pre-diabetic stages.

The transition from the early metabolic abnormalities that precede diabetes, impaired fasting glucose (IFG) and impaired glucose tolerance (IGT), to diabetes may take many years; however, current estimates indicate that most individuals (up to 70%) with these pre-diabetic states eventually develop diabetes. During the pre-diabetic state, the risk of a cardiovascular disease (CVD) event is increased by 50%, compared to the normal population. With the development of diabetes, however, there is a large (four fold) increase in risk for CVD, as well as for long-term complications affecting the eyes, kidneys, and nervous system. The complications of diabetes, which are the cause of major morbidity and mortality, are related to its duration, the metabolic alterations in physiology due to insulin resistance, chronic exposure to hyperglycemia, and other risk factors.

Although clinical trials have demonstrated the effectiveness of intensive glycemic and blood pressure control to reduce the long-term complications of diabetes, the public health burden of the disease remains enormous. The magnitude of the epidemic, coupled with complex treatment requirements that are difficult and costly to implement, make the prevention of diabetes a critical public health goal. Between 1997 and 2006, eight major clinical trials examined whether lifestyle or pharmacologic interventions would prevent or delay the development of diabetes in populations at high risk by virtue of having IFG and/or IGT.

The study populations often had other recognized risk factors for diabetes including obesity, a prior history of gestational diabetes, or a positive family history of diabetes. All of these trials demonstrated reductions in the development of diabetes of 25-60% over the period of follow-up. The largest reductions (>60%) were accomplished with lifestyle interventions aimed at weight loss and increasing physical activity and with an insulin sensitizing medication. Lesser degrees of reduction (25-30%) have been achieved with other drugs.

It is extremely important to be able to identify and increase recognition of patients in a pre-diabetic state. Patterns of biomarkers such as cholesterol profiles characterized by low HDL, high triglycerides, and high VLDL can identify these patients, even in the presence of normal blood sugars. Additional indicators include elevated fasting insulin, family history of diabetes, a history of gestational diabetes, polycystic ovary, increased visceral fat, hypertension and others.

Specific metabolic profiling strategies have been developed that can differentiate between various pre-diabetic states and therefore provide more precise preventive strategies. An example is a “Glucose-Insulin Stress Test” which assesses the responses of glucose, C-peptide and insulin to a glycemic load. Furthermore, the use of high-resolution ultrasound to identify regional visceral fat deposition (e.g., liver, abdominal, epicardial) 4 may indicate severity of metabolic imbalance and therapeutic targets. These assessments may also assist in the recognition and prevention of other medical consequences of insulin resistance, such as diastolic congestive heart failure and Alzheimer's disease.

A link has been identified between increased insulin resistance and vascular plaque development. Thus, identifying patients with this metabolic predisposition and adjusting the level of scrutiny or preventative treatment for cardiovascular disease could significantly reduce cardiovascular morbidity and mortality.

In addition to atherosclerotic burden, the metabolic milieu is a critical factor in determining cardiovascular risk. Vascular physiology and the state of metabolic balance with regard to glucose and insulin handling (pre-diabetes and diabetes) may be fundamental to evaluating health. Imbalances in these areas are contributed to by both genetic and environmental factors. The relative contribution of genetics and the environment vary from person to person and underscore the need for individualized assessments and treatment recommendations.

Vascular and metabolic systems interact, each influencing the other with an associated compounding of risk in states of dysfunction. For example, patients with a pre-diabetic condition have changes in their cholesterol profiles that result in an increased risk of cardiovascular disease. Residual cardiovascular risk remains from this metabolic imbalance even if medications are used to reduce LDL cholesterol. Additional treatments in the form of validated supplements and prescription medications can be used to target the non-LDL cholesterol lipid abnormalities that characterize this condition and reduce residual risk. Furthermore, it has been determined that the risk of heart attack in patients with diabetes is equal to the risk of a non-diabetic patients who have already had a heart attack. Other studies have determined that having diabetes is the equivalent of aging 15 years with regard to cardiovascular risk.

### B. Report Server System

Turning now to FIG. 1, an example report server system 100 will be described. The report server system 100 illustrated in FIG. 1 can obtain and analyze patient data and produce reports that, e.g., summarize the appropriateness of a patient's beta cell insulin production in a way that it is understandable and clinically relevant.

The report server system 100 may be configured to provide computing resources to one or more client computing systems 104 via a communication network 108. The report server system 100 can manage requests from a user of a client computing system 104 to execute a program, or set of programs, on behalf of the user. At least some of the client computing systems 104 can be remote from the report server system 100.

The network 108 can, for example, be a publicly accessible network of linked networks, such as the Internet, possibly operated by various distinct parties. In other embodiments, the network 108 can be a private network, such as, for example, a corporate, university or hospital network that is wholly or partially inaccessible to non-privileged users. In still other embodiments, the network 108 can include one or more private networks with access to and/or from the Internet. The network 108 may be any wired network, wireless network, or some combination thereof. In addition, the network 108 may be a personal area network, local area network, wide area network, cable network, satellite network, cellular telephone network, etc., or any combination thereof.

Client computing systems 104 may be located in one or more hospitals, individual or group physician practices, laboratories, diagnostic imaging centers, individual patient homes, etc. The client computing systems 104 can include any of a variety of computing devices, including but not limited to desktop computers, personal digital assistants (PDAS), smart phones, laptop computers, tablet computers, or other portable electronic devices.

The report server system 100 may be implemented as one or more physical or virtual computing devices, such as servers. In multi-device implementations, the devices may communicate via a communication network 128. The communication network 128 can include multiple networking devices (not shown) such as, e.g., switches, routers, etc. The network 128 can, but need not be, a different network than the network 108 shown in FIG. 1. The network 128 may be a wired network or a wireless network, or some combination thereof. In addition, the network 128 may be a personal area network, local area network, wide area network, cable network, satellite network, cellular telephone network, the Internet, etc., or any combination thereof.

The report server 100 can include various modules and components, such as a beta cell processor 130, a report generator 132, and any number of storage nodes 134. Each of the modules and components of the report server 100 may be implemented on a separate computing device, or various modules and components may share one or more computing devices. In some embodiments, the features and services provided by the report server system 100 may be implemented as web services consumable via the communication network 108. In further embodiments, the report server system 100 is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

Generally described, the report server system 100 can provide a variety of functionality for analyzing patient data and generating reports. In some embodiments, the report server system 100 manages execution of programs and generation of reports for any number of users, stores data, and/or transfers data to and from client computing systems 104. For example, a client computing system 104 (e.g., a computer operated by a doctor or a patient) may request a report from the report server system 100 via network 108. The report server system 100 may then request data via the communication network 108 from one or more computing systems, such as the client computing system 104 which requested the report and/or another computing system which provides access to or otherwise manages the stored data (e.g., a storage server operated by a group practice, laboratory, hospital, or the like). The report server system 100 can receive the data over the communication network 108, generate a report, and then send the report to one or more client computing systems 104 via the communication network 108. In some embodiments, the report server system 100 stores the report in a memory location for retrieval by a client computing system 104.

The report server system 100 can include one or more storage nodes 134 that provide mass storage of data, programs, and other user information. The storage nodes 134 can include any type of persistent data storage, for example non-volatile memory devices such as, e.g., hard disk drives, optical disk drives, etc. The storage nodes 134 may be accessible to the other components and devices of the report server system 100 via the communication network 128. In some embodiments, some or all of the storage nodes 134 may be remote from the report server system 100 and therefore may be accessible via the communication network 108, or via some other communication link.

A beta cell processor 130 implemented by the report server system 100 can generate and provide data to users or applications of the report server system 100. For example, the beta cell processor 130 can receive requests from client computing systems 104, via the network 108, to generate a beta cell calculation. The beta cell processor 130 can automatically retrieve patient data relating to demographics, laboratory results, and imaging results, calculate a patient's beta cell responsiveness, and generate a user-friendly score. In some embodiments, the beta cell processor 130 may also perform one or more of the following functions: assign a risk index to the patient, incorporate other patient-specific data, health information, and treatment options, and generate a report, as described in greater detail, below. The beta cell processor 130 may provide its results to the report generator 132 (e.g., for generation of a formatted report or to be delivered to a client computing system 104), store the results in a data store (e.g., one or more of the storage nodes 134), or transmit the results directly to a user or client computing system 104.

In some embodiments, the beta cell processor 130 is executed or embodied by one or more physical or virtual computing systems. For example, one or more server computing systems that have components including a CPU, I/O components, storage, and memory can be used to execute the beta cell processor 130. In one embodiment the beta cell processor 130 is stored as one or more executable program modules (e.g., instruction sets, lines of code, executable files, virtual machines, etc.) in the memory of a server or servers associated with the report server system 100. The term “module” is a broad term intended to have its broadest, ordinary meaning. In addition, the term “module” can refer to a set of computer-processor-executable instructions (e.g., an instruction set) that may be grouped together as a distinct unit or distributed within a memory of a single computing device, or within the memories of multiple computing devices.

### C. Metabolic Profile Reporting System

Features related to the analysis of patient data and generation of reports based on beta cell responsiveness will be described in the context of an example metabolic profile reporting system shown in FIGS. 2A and 2B. In particular, FIG. 2A illustrates an embodiment of a network computing environment 200A that includes a report server system 100, one or more client computing systems 104, an electronic health record (EHR) system 220A, and a reference data store 224. The systems and components of the network computing environment 200A can communicate via a network 108. FIG. 2B illustrates another embodiment of a computing environment 200B that can include the same or similar systems and components as the network computing environment 200A of FIG. 2A. However, the EHR system 200B in FIG. 2B is included in or associated with the report server system 100. In addition, the EHR system 200B can include an integrated beta cell processor 130B. In some embodiments, various systems or components of the computing environments 200A, 200B may be implemented in any clinical facility, including a hospital, an outpatient care center, a lab, a doctor's office, skilled nursing and assisted living facilities and the like, or in a data center separate from a clinical facility. In some embodiments, various systems or components of the computing environments 200A, 200B may be implemented at a remote computing and storage provider, such as a cloud computing provider.

Referring now to FIG. 2A, the beta cell processor 130A communicates with the EHR system 220A over a network 108, which can be a clinical facility LAN, a WAN, the Internet, combinations of the same, or the like. Also shown in communication with the network 108 are one or more client computing systems 104. Further, in communication with the beta cell processor 130A is a report generator 132. Each of these systems shown can be implemented using software and/or computer hardware (example hardware is described in greater detail below).

Referring to FIG. 2B, the beta cell processor 130B is implemented as part of an EHR system 220B. Integrating the beta cell processor 130 with the EHR system 220B can provide the benefit of faster performance, reduced security risks, etc. Thus, in the depicted embodiment, the beta cell processor 130B does not need to communicate over a network 108 to extract or receive data from the EHR system 220B; rather, the beta cell processor 130B may have more direct access to data stored in an EHR data repository 240. The EHR data repository 240 can therefore also serve as a repository for storing model data (described below), thereby reducing or eliminating the need for a separate model data store 218, such as the one shown in FIG. 2A.

In either FIG. 2A or 2B, the beta cell processor 130 may include a beta cell calculation module 230, a risk stratification module 234, and a model creation engine 238. The features and operation of the modules and components of the beta cell processor 130 are described in detail below. In either FIG. 2A or 2B, the beta cell processor 130 can include software that executes on one or more computing devices, such as one or more physical server computers. In embodiments where the beta cell processor 130 is implemented on multiple servers, these servers can be co-located or can be geographically separate (such as in separate data centers). In addition, the beta cell processor 130 can be implemented in a cloud computing platform. For example, the beta cell processor 130 can be implemented in one or more virtual machines that execute on one or more physical servers. More generally, the beta cell processor 130 can be implemented as software-as-a-service (SaaS), using an application service provider model or the like.

In operation, a beta cell processor 130 can communicate with an EHR 220 to obtain demographic information, laboratory results, diagnostic imaging data or other stored data for one or more patients. The beta cell processor 130 can programmatically analyze this data to calculate a beta cell responsiveness score indicative of beta cell responsiveness. For convenience, such a score may also be referred to simply as a beta cell score. In one embodiment, the beta cell calculation module 230 determines the appropriateness of a patient's beta cell responsiveness based on the analyzed data and provides an easy-to-interpret beta cell score, which may be provided to or made available to a patient, clinician or other user.

The risk stratification module 234 may then utilize the beta cell score, alone or in conjunction with other patient data, to assign the patient to one of a number of predetermined risk categories, which may be modified over time. For example, the risk stratification module 234 may also receive data from the EHR system 220, and may assign the patient to a risk category based on such data, as described in detail below. Furthermore, predetermined rules may be used to weigh certain input data (e.g. the beta cell score), and the weighted input data may be used in conjunction with other input data to determine an adjusted risk category. The model creation engine may 238 may be used to determine the weights assigned to certain data relative to other data. The risk categories assigned to patients may be set so that they are associative to patients and thus increase the impact on the patients. This can cause an improvement in the compliance rate with treatment options.

In some embodiments, the beta cell score may be used by the model creation engine 238 to modify target values for other laboratory tests, patient information (such as weight, body mass index (BMI), exercise, caloric intake, or other) or diagnostic imaging results. Similarly, the model creation engine 238 may adjust risk assignment categories for other parameters (e.g., atherosclerotic risk) based on the beta cell score. In some embodiments, the beta cell processor 130 can generate one or more of a beta cell score, a beta cell risk category, and other value risk categories

The EHR 220A can include software and systems to store and provide access to electronic medical records (EMR). In many systems, the terms “EHR” and “EMR” are used synonymously. Other terms commonly used to refer to the EHR 220A and its data include electronic patient records (EPR) and computerized patient records. More generally, it should be understood that in addition to having its ordinary meaning, the term “EHR,” as used herein, can refer to any system or database that stores patient data. This patient data can include notes by clinicians (e.g., doctors, nurses, technicians, or other clinical staff) such as discharge summaries, and/or structured clinical event data. This patient data may also include laboratory results, diagnostic imaging results, and inputted patient demographic information.

Patient result data is often provided to the EHR 220A via client computing systems 104 over the network 108. These client computing systems 104 can include bedside monitors or other medical devices that obtain physiological monitoring data from patients. The client computing systems 104 can also include user computing devices operated by clinicians for the purpose of entering a record of any of the following information, among others: medicines the patient is taking, allergies, lab reports including culture reports, radiology reports, and the like, treatments performed by clinicians or medical devices, and so on. The EHR data system 220A may also include the results of a patient oral glucose tolerance test (OGTT). In one embodiment, the client computing systems 104 include hospital systems, clinician computing systems, PDAs, telephones, computers, tablets, smart phones, or other devices operated by clinicians, patient devices, and the like. These client computing systems 104 may, but need not be, in the same location as the EHR system 220A. Furthermore, multiple client computing systems 104 may transmit and/or receive data over the network 108 to and/or from the report server system 100.

The EHR system 220A may receive patient data from one or more client computing systems 104 and store this data in an EHR data repository 240. The EHR data repository 240 can include one or more databases implemented in one or more physical computer storage devices. The EHR data repository 240 can include data structures, such as tables, that map patient identification codes to clinical data in a secure environment in order to protect patient privacy. In some embodiments, the report server system protects patient privacy by only retrieving clinical data and patient ID codes, rather than retrieving actual patient identification information.

In some embodiments, the model creation engine 238 includes a predetermined model that describes a relationship between various physiological parameters. The model can be used by the beta cell processor 130 to generate a beta cell score. The model can be determined based upon clinical data from a variety of clinical subjects. In other embodiments, the beta cell processor 130 includes a model creation engine 238 that generates such a model. The model creation engine 238 can use electronic and/or human input to create a model that extracts rules based on the EHR data 240 or the reference data 224. The reference data 224 may include information about treatment options, information about medical conditions such as diabetes, heart disease, carotid atherosclerotic disease, and other vascular or metabolic conditions and preconditions. For example, by using statistical analysis techniques, the model creation engine 238 can determine from the reference data 224 that certain information about diabetes is relevant to patients with moderate risk and/or that certain medications may be recommended. The model creation engine 238 can then store a rule in a model data repository 218 that maps the information to patients with beta cell responsiveness scores indicating moderate risk. The information and/or recommended medications may be further provided to the report generator 132. The rules created by the model creation engine 238 can be refined or added to by an expert, such as a clinician. In other embodiments, a clinician or other individual provides the rules to the model creation engine 238 instead of the model creation engine 238 automatically obtaining the rules from the reference data repository 224.

The model creation engine 238 can then assign weights to the rules automatically in a training process that uses actual clinical event data and known health outcomes. Each weight can reflect the degree to which a given patient risk factor (e.g., the beta cell responsiveness score) is indicative of a given outcome (e.g., risk of cardiovascular incident). In several embodiments, the weights are in the range of (0, 1], where 1 indicates a high degree of correlation between a feature and an outcome close to 0 indicates low correlation between a feature and an outcome (if the correlation is 0, the rule might not be stored). The weights can also have a range other than (0, 1]. While such a weight could be hand-tuned by an expert, hand-tuning a large data set like the EHR data repository 240 could be extremely time-intensive, less efficient, and potentially less accurate than using an automated training process.

The model creation engine 238 can store the rules, together with their weights, as a model in the model data repository 218. The model creation engine 238 can construct different models for different patient populations, such as population models based on age or gender or location or family history, and so forth. Alternatively, the model creation engine 238 can construct a monolithic model that represents multiple (or all) patient populations.

Furthermore, as will be discussed in detail below, the model creation engine 238 may be used to create or modify the model applied by the beta cell calculation module 230. In some embodiments, the model creation engine 238 is run once to generate a model for the beta cell calculation module 230, when the beta cell processor 130 is initialized. In another embodiment, the model creation engine 238 is run once prior to initialization of the beta cell processor 130. Thus, the model data repository 218 can be supplied to a clinical facility or other client with a pre-generated model based on data from a representative population. The model creation engine 238 can therefore be a separate component of the beta cell processor 130 in some embodiments, and not included in a clinical facility installation. In other embodiments, the model creation engine 238 can refine the model after the model is initially created, for example, by continually or periodically analyzing the patient data in the EHR data repository 240. In some embodiments, a model creation engine 238 which may only create or refine certain models, for example, the risk stratification module model, may be provided to a client.

The report generator 132 may receive output from the beta cell calculation module 230 and the risk stratification module 234. The report generator 132 may request and receive input from the reference data 224 and/or EHR data 240 repositories, or the input may be automatically extracted and provided to the report generator 132. In some instances, the automatic extraction may be guided by rules either generated by the model creation engine 238 or entered by an individual. The report generator 132 may then arrange the data into a report which is clinically relevant, easily digested by a patient, and designed to capture and maintain patient attention, such that the patient is more likely to be compliant with a health regimen recommended on the basis of the findings in the report.

### D. Computer Implemented Process for Providing Beta Cell Responsiveness Report

FIG. 3 illustrates an embodiment of a computer implemented process 300 for providing a Beta Cell Responsiveness Report (BCRR). The report provision process 300 may be implemented by the report server system 100.

The process 300 begins at block 302. For example, if the process 300 is implemented by a report server system 100, the process 300 may begin automatically upon power up or it may be manually initiated by a user wishing to obtain a Beta Cell Responsiveness Report. The process 300 may be embodied in a set of executable program instructions stored on a computer-readable medium, such as one or more disk drives, of a computing device associated with the report server system 100. When the process 300 is initiated, the executable program instructions can be loaded into memory, such as RAM, and executed by one or more processors of the computing device(s). In some embodiments, the process 300 may be executed by multiple computing devices, serially or in parallel.

At block 304, the computing device or devices executing the process 300 (e.g., a computing device associated with report server system 100 or some module or component thereof) receives a request for one or more Beta Cell Responsiveness Reports. The request/s may come from a user of a client computing system 104 directly or over an electronic network 108. The user may be a hospital, outpatient facility, physician office, clinician mobile device (such as a PDA, laptop computer, tablet computer, smart phone, or other similar device), laboratory, or diagnostic imaging center, among others.

At block 306, the report server system 100 accesses and retrieves patient data from an EHS or EHR data repository such as, for example, EHR 220A, 220B or directly from a EHR data repository 240. The report server system 100 may access a single patient's data at a time or data from multiple patients at the same time. The report server system 100 may access patient data from a single source or multiple sources. The data may be accessed over a network (e.g. network 108) or, if the EHR data repository is integrated with the report server system 100, it may be directly acquired (as in FIG. 2B). The report server system 100 may extract patient demographic, laboratory, and/or diagnostic imaging results based on a predetermined set of data to be acquired. The set may be predetermined by the user request or by the report server system 100 parameters. In some embodiments, the report server system 100 searches the patient data, automatically extracts all potentially relevant data, and incorporates it into the report.

In block 308, a beta cell processor 130 or some other component of the report server system 100 calculates a beta cell responsiveness score based on patient data, such as an OGTT, as further explained below. Further, the beta cell processor 130 may or some other component or module may, in some instances, assign the patient to a risk category based on the beta cell responsiveness score. The beta cell processor 130 may also assign other patient data to separate risk categories, either directly based on data results or by weighting the data based on other information, such as the beta cell responsiveness score, demographic data, other medical conditions or preconditions, etc.

At block 310, the report server system 100 generates a Beta Cell Responsiveness Report, including a beta cell responsiveness score. Other patient data and laboratory/imaging results may be provided, as may risk category assessments based on multiple parameters. Furthermore, treatment recommendations based on the patient risk categories may be provided. These may be frequently updated to reflect current practice. It may also be desirable to provide explanations of normal and pathologic function associated with diabetes and/or other health conditions in a way that is easily understandable, attracts and maintains patient focus and concern, and may therefore improve patient compliance. The report generator 132 or some other module or component of the report server system 100 may extract information and treatment data based on the beta cell responsiveness score and may modify this based on other patient factors or risk categories.

At block 312, the report server system 100 provides a Beta Cell Responsiveness Report to a user. The BCRR may be provided to the original requestor, or to one or more third parties, such as directly to a patient, or to both. The BCRR may be provided over a network 118 to one or more client computing systems 104. In some embodiments, the BCRR may be provided as an email attachment, accessed through a web portal, or sent to a printer such that a hard copy is provided to one or more users. In other embodiments, the BCRR may be provided on a memory device such as a CD, DVD, memory stick, disc drive, or any other storage device. In some embodiments, at block 312 the BCRR is stored in memory and made available for download, viewing, or retrieval by a user at their convenience.

### E. Process for Generating Beta Cell Responsiveness Score and Diabetic Risk Category

FIG. 4 illustrates an embodiment of a process 400 for generating a Beta Cell Responsiveness Score and Diabetic Risk Category for a patient. In some embodiments, the process 400 may be implemented by a beta cell processor 130 or some other module or component of a report server system 100.

The process 400 begins at block 402. For example, if the process 400 is implemented by a report server system 100 or some module or component thereof, the process 400 may begin automatically upon power up or it may be manually initiated by a user wishing to obtain a Beta Cell Responsiveness Score or a Beta Cell Responsiveness Report. The process 400 may be embodied in a set of executable program instructions stored on a computer-readable medium, such as one or more disk drives, of a computing device associated with the report server system 100. When the process 400 is initiated, the executable program instructions can be loaded into memory, such as RAM, and executed by one or more processors of the computing device(s). In some embodiments, the process 400 may be executed by multiple computing devices, serially or in parallel.

At block 404, the computing device or devices executing the process 400 (e.g., a computing device associated with the beta cell processor 130 or some other module or component of the report server system 100) acquires patient data from which to determine the Beta Cell Responsiveness Score. The beta cell processor 130 may acquire the data directly from an Electronic Health System (e.g., EHS 220) or Electronic Health Data Repository (e.g., EHD data repository 240), either directly or over a network 108. In some embodiments, the beta cell processor 130 may acquire data from a client computing system 104. In some embodiments, the beta cell processor 130 acquires the patient data from a report server system. The data acquired may include the results of one or more laboratory tests; for example, an oral glucose tolerance test Oral Glucose Tolerance Test, which provides tabulated data over various predetermined time periods, as shown in Table 1 below:

### Sample Data:

TABLE 1

| | | 30 | 60 | 120 |
|---|---|---|---|---|
| | TIME 0 | MINUTES | MINUTES | MINUTES |
| GLUCOSE | G⁰ = 90 | G³⁰ = 122 | G⁶⁰ = 130 | G¹²⁰ = 101 |
| INSULIN | I⁰ = 5 | I³⁰ = 35 | I⁶⁰ = 55 | I¹²⁰ = 24 |
| C-PEPTIDE | C⁰ = 2 | C³⁰ = 5 | C⁶⁰ = 8 | C¹²⁰ = 4.5 |

Additional or alternative laboratory test results may be obtained by the beta cell processor 130.

At block 406, the beta cell calculation module 230 may determines a Beta Cell Responsiveness Score, as described in detail below in reference to FIG. 5. At block 408, the score is used to assign the patient to a diabetes risk category (e.g., by a risk stratification module 234). The category determination may be made based on predetermined ranges of Beta Cell Responsiveness Scores, which may be absolute, or may be adjusted based on one or more parameters, such as age, weight, concomitant medical conditions or medications, family history, or other. The category ranges may be adjusted automatically based on a model change, or based on manual changes. A model change may occur based on evaluation of beta cell scores over time and correlation with clinical outcomes, or with changes in the output of the beta cell calculation module 230 or some other module, component, or system. Furthermore, it may be particularly useful to present the risk categories in a manner which maximizes their impact and understandability. For example, it may be visually stimulating to report a patient's diabetes risk category in a red-yellow-green format, wherein green is normal, yellow is at risk for developing diabetes, and red is considered diabetic. This presentation may successfully capture a patient's attention because the red-yellow-green format is associated with stoplights and safety. In other embodiments, four or five or six risk categories may be identified, such that low/medium/high risks are separately identified. These may be distinguished by shape or color, or may simply be labeled low, medium, and high risk (as well as normal or diabetic). Other methods of distinguishing between conditions may include type color or font. It will be apparent that any labeling system, whether verbal, visual, or a combination of the two, which increases patient recognition of their condition, attracts and maintains attention, or in any way renders the transfer of information to the patient more effective, such that compliance is increased and outcomes are improved, may be utilized.

In block 410, the beta cell processor provides the Beta Cell Responsiveness Score and risk category to, for example, a report generator 132. The score and category information may be provided over a wired or wireless interface, through internet, intranet, or LAN. The score and category information may be provided on any memory device. Information may be provided for one patient or many patients. In one embodiment, scores and category information for dozens or hundreds of patients are provided electronically by the process 400.

### F. Beta Cell Responsiveness Score

The Beta Cell Responsiveness Score reflects the appropriateness of the beta cell response to a glucose load, given the level of insulin resistance of an individual. For example, if a patient's tissues have some insulin resistance compared to individuals with normal metabolic function, the patient's pancreatic beta cells will generally release more insulin to maintain a normal blood glucose level. As function worsens, the beta cells will begin to fail and/or no longer be able to respond commensurate with the level of insulin resistance.

In one embodiment, an index known as a Matsuda index is used to indicate appropriateness of an individual's response to a glucose load. In other embodiments, a modified Matsuda index is used to indicate such appropriateness. The modified Matsuda index is determined by multiplying the Matsuda index (MI) value by the ratio of the patient's C-Peptide AUC/Glucose AVC value. However, although these appropriateness indicators may be useful in distinguishing diabetic patients from non-diabetic patients, they do not provide a convenient reporting form, and as values diverge from those of the majority of the population, the values become distorted, as neither equation produces linear results given relatively high or low values. Therefore, these indicators are not particularly useful for predictive purposes. Furthermore, in order to understand the resultant values, comparison values must be provided and accurately set against a patient's values. This is not convenient, and many patients may either not understand the impact of their number or be put off by the difficulty in interpretation.

A novel means of determining and reporting the appropriateness of beta cell responsiveness permits meaningful quantification along a predetermined, repeatable, linear scale. In some embodiments, a one hundred point scale is used, although the method may be configured to provide, for example, a 50 point scale, a 200 point scale, a 10 point scale, a 500 point scale or a 1000 point scale. This type of scale may be useful for reporting to patients in a way that is understandable and communicates the level of risk effectively to them. This may also be very useful for medical practitioners to use in determining a treatment regimen.

The beta cell calculation described above may improve the ability to accurately understand where along the normal to diabetic continuum a patient lies. This in turn, may allow improved treatment recommendations by clinicians and improved understanding of their condition and compliance with preventative health care measures by patients. The study below illustrates the importance of identifying pre-diabetic patients and treating appropriately.

Study 1

Impaired glucose tolerance (IGT) and impaired fasting glucose (IFG) are pre-diabetic states with lifetime conversion to diabetes of ˜50%. From plasma glucose, insulin, and C-peptide concentrations during OGTT (oral glucose tolerance test), indices of insulin sensitivity and insulin secretion may be derived. The effectiveness of targeted pharmacologic interventions to reverse documented pathophysiologic abnormalities in prediabetes was studied.

105 primary care patients with IGT and/or IFG were treated with (i) insulin sensitizers (pioglitazone plus metformin (PIO/MET)) (n=40); (ii) or insulin sensitizers plus exenatide (EXEN) (n=47) based upon OGTT-derived indices of insulin resistance and impaired beta cell function. Subjects (n=18) refusing pharmacologic therapy received lifestyle modification only.

After a mean of 8.9 months, the lifestyle group demonstrated no significant changes in FPG (fasting plasma glucose), plasma glucose (PG) AUC during OGTT, insulin sensitivity, or beta cell function. 2 of 16 patients reverted from IFG to NGT, no patient reverted from IGT to NGT and one patient developed diabetes. In PIO/MET (24 hours off medication), FPG fell from 109 to 102 mg/dl and PG AUC declined by 12.0%; insulin sensitivity and beta cell function improved by 42% and 50% (all p<0.001); 14.3% converted to normal glucose tolerance (NGT); none developed diabetes. In PIO/MET/EXEN (24 hours off medication), FPG fell from 109 to 98 mg/dl and PG AUC declined by 21.2%; insulin sensitivity and beta cell function improved by 52% and 109% (all p<0.0001); 59.1% of IGT subjects reverted to NGT; none developed diabetes.

In conclusion, it appeared that targeted pathophysiologic therapy based upon OGTT-derived measures of insulin sensitivity and beta cell function can be implemented in general internal medicine/endocrine practices and is associated with marked improvement in glucose tolerance and reversion of pre-diabetes to NGT in over 50% of individuals.

Therefore, the Beta Cell Responsiveness Score may be particularly clinically important, as being able to assign a patient's response to the continuum between normal and diabetic may permit the implementation of an individualized treatment plan which has the greatest likelihood of preventing further progression and perhaps avoiding diabetes altogether.

### G. Generating a Beta Cell Responsiveness Score

FIG. 5 illustrates an embodiment of a process 500 for generating a Beta Cell Responsiveness Score (BCRS). The score generation process 500 may be implemented by the beta cell calculation module 230 described above.

The process 500 begins at block 502. For example, if the process 500 is implemented by a beta cell calculation module 230 or some module or component thereof, the process 500 may begin automatically upon power up or it may be manually initiated by a user wishing to obtain a Beta Cell Responsiveness Score or a Beta Cell Responsiveness Report. The process 500 may be embodied in a set of executable program instructions stored on a computer-readable medium, such as one or more disk drives, of a computing device associated with the report server system 100. When the process 500 is initiated, the executable program instructions can be loaded into memory, such as RAM, and executed by one or more processors of the computing device(s). In some embodiments, the process 500 may be executed by multiple computing devices, serially or in parallel.

At block 504, the computing device or devices executing the process 500 (e.g., a computing device associated with the beta cell calculation module 230) acquires data relating to the physiological condition of one or more patients. The process 500 proceeds to block 506, where it calculates an insulin resistance index for one or more patients. At block 508, the process 500 calculates a insulin release index. At block 510, the process 500 scales the insulin release index and insulin resistance index in accordance with a predetermined model, such that they are weighted relatively equally. The process 500 continues to block 512 with adjustment of the scaled insulin release index and insulin resistance index according to the model to correct for non-linearity of high and low patient results. In block 514, the appropriateness of the beta cell response given concomitant level of insulin resistance is calculated using values derived from the model. In step 516, the Appropriateness score calculated in step 514 is manipulated to generate an understandable, easily quantifiable, and clinically meaningful Beta Cell Responsiveness Score on a predetermined scale.

Furthermore, prior to performing the process 500, or as the first block of the process, a Beta Cell Responsiveness Score calculation model is executed. This model may be provided with the Beta Cell Processor or may be uploaded separately. It may be possible to modify parts or all of the model either with user input changes or with automatic model generation, or it may not be modifiable. There may be a single model or multiple models, based on certain patient populations.

At block 504, the Beta Cell Calculation Module 230 or other means of carrying out the process 500 acquires patient data. This may be laboratory result data, specifically laboratory result data relating to the relationships between serum (or urine or other fluid) glucose, c-peptide, and insulin levels at a given time. In some embodiments, the data used is derived from an OGTT (oral glucose tolerance test), which provides serum glucose, c-peptide and insulin measurements for 0 minutes after glucose, 30 minutes after glucose, 60 minutes after glucose, and 120 minutes after glucose challenge. Alternative laboratory tests may be used, with adjustment of the model based on population results. For example, if the initial glucose dose is changed, the absolute values will need to be scaled. Similarly, it may be necessary to perform calculations to normalize data from individual laboratories, so that comparison between laboratories accurately represents patient physiology.

At block 506, the Beta Cell Calculation module 230 calculates the insulin resistance index. For example, a Matsuda index calculation may be performed to generally reflect the degree of insulin resistance, as calculated below:

Standard Matsuda Index=10,000×{square root over ((G⁰×I⁰×(AVG G³⁰:G¹²⁰)×(AVG I³⁰:I¹²⁰))}

The beta cell calculation module 230 may then modify the Matsuda value; for example, by adding a first predetermined constant, such that the resulting insulin resistance index value may be appropriately adjusted, for example, at block 512. Alternatively, other means of approximating the degree of insulin resistance may be used with other embodiments of the beta cell score calculation model, for example when different laboratory tests yielding different results are used to calculate the degree of insulin resistance.

At block 508, the insulin release index is calculated by the Beta Cell Calculation module 230. For example, the insulin release by beta cells may be approximated by the ratio of the area under the curve (AUC) of C-Peptide levels to the AUC of Glucose levels, based on OGTT results, as described below.

$$C \text{-} PEP AUC / GLU AUC = \frac{\frac{( {C}^{0} + {C}^{30} )}{4} + \frac{( {C}^{30} + {C}^{60} )}{4} + \frac{( {C}^{60} + {C}^{120} )}{2} - ( 2 \times {C}^{0} )}{\frac{( {G}^{0} + {G}^{30} )}{4} + \frac{( {G}^{30} + {G}^{60} )}{4} + \frac{( {G}^{60} + {G}^{120} )}{2} - ( 2 \times {G}^{0} )}$$

Predetermined second and/or third constants may be added to the C-Pep AUC and GLU AUC based on the beta cell responsiveness score model to ensure; for example, that the resulting ratio is a positive number.

At block 510, the model is executed to scale the insulin resistance index and/or the insulin release index. For example, a first predetermined coefficient may be applied to the insulin release index, as further explained below in reference to FIG. 6.

At block 512, the Beta Cell Calculation module 230 adjusts the scaled insulin release index and insulin resistance index to correct for non-linearity at extremes. This may be done, for example, by taking the log of each value and multiplying by a second and/or third predetermined coefficient, as discussed below. This yields an adjusted insulin release index value and an adjusted insulin resistance index value

At block 514, the appropriateness of the beta cell response is calculated using the model; for example, by dividing the adjusted insulin release value by the result of subtracting the adjusted insulin resistance value from a fourth predetermined constant. In some embodiments, the range of values yielded by application of block 514 is >0 and <1=1.

At block 516, the Beta Cell Calculation module 230 generates a user friendly BCRS. For example, the value resulting from block 514 may be multiplied by a fourth coefficient, such that the range of scores may be from 0 to the value of the fourth coefficient. This range may be set, for example, at 0-100. In other embodiments, the range may be, for example, 0-10, 0-50, 0-500, 0-1000, or any other convenient set of numbers which may be readily understood by patients and clinicians, and permit the patient or clinician to accurately interpret the number in terms of risk prediction.

In addition to the potential benefits of the beta cell processor 130 in the identification of pre-diabetic state and use in generating reports to improve preventative health outcomes, the beta cell processor 130 can provide benefits in other contexts. For instance, the beta cell responsiveness scores output by the beta cell processor 130 can serve as a basis for clinical trial recruitment, research, bio-surveillance, or other applications. Patient outcome correlation with beta cell responsiveness scores can benefit clinical trial recruitment in some embodiments by enabling researchers to identify subjects who are known to have a particular metabolic profile (e.g., based on analysis by the beta cell processor 130). Furthermore, correlation of beta cell responsiveness scores over time with concomitant disease and/or the likelihood of developing concomitant cardiovascular or other metabolic disease, may permit adjustment of risk classification for these disease based on a patient's diabetic risk profile as evidenced by the beta cell responsiveness score. The beta cell processor 130 can also have applications in other areas than those mentioned.

It should also be noted that it may not be feasible for an individual to manually perform the analysis of laboratory results such as the OGTT as described herein in order to obtain a Beta Cell Responsiveness Score for an individual. Compound this data among many patients, and the task of performing the Beta Cell Responsiveness Score calculations would quickly become impossible with the human mind or pencil and paper alone. Even with a calculator to manage some of the functions, it would take significant time and may carry a significant risk of inaccuracy. Furthermore, in some embodiments, the resulting BCRS is utilized in calculating risk indices for other patient values, requiring significantly more time if attempted without a computer. Amassing and arranging other laboratory results for inclusion in the report, assignment of risk categories to the results, providing information regarding health conditions, and suggested treatment regimens based on the scores would not be feasible to perform manually for one patient, much less for large numbers of patients. In contrast, the systems described herein can, in certain embodiments, automatically analyze patient data and execute the beta cell model much faster than a human could do, making such analysis feasible to do. As one example, a computer system implementing embodiments of the features described herein may be able to process records for a patient in real time, or can identify scores and generate reports in less than a minute, or less than two minutes, or less than five minutes, or less than some other time.

### H. Generating a Model for Beta Cell Responsiveness Score Calculation

FIG. 6 is a flow chart of an illustrative process 600 for generating a model for calculating a Beta Cell Responsiveness Score. Such a model may be generated once or may be adjusted or re-generated over time. Furthermore, the model may be adjusted to account for differences between laboratories or to account for different tests used.

The process 600 begins at block 602. For example, if the process 600 is implemented by a report server system 100 or some module or component thereof, the process 600 may begin automatically upon power up or it may be manually initiated. The process 600 may be embodied in a set of executable program instructions stored on a computer-readable medium, such as one or more disk drives, of a computing device associated with the report server system 100. When the process 600 is initiated, the executable program instructions can be loaded into memory, such as RAM, and executed by one or more processors of the computing device(s). In some embodiments, the process 600 may be executed by multiple computing devices, serially or in parallel.

In block 604, the computing device or devices executing the process may retrieve laboratory data for a patient population from a user computing system, EHR, or some other source. The laboratory data may include one or more standard or customized tests for measuring serum (or urine) glucose, insulin, C-peptide levels or other indices of metabolic function or dysfunction. Multiple measurements may be obtained over time in one or more sessions. For example, results of an oral glucose tolerance test may be obtained for a number of patients. In one example, a model may be built when a sample population of 350 patients with normal glucose tolerance is tested and the results retrieved by, for example a model creation engine.

In block 606, population laboratory data is used to determine an insulin resistance index calculation. For example, a baseline Matsuda index calculation may be performed to generally reflect the degree of insulin resistance, as calculated below:

Matsuda Index=10,000×{square root over ((G⁰×I⁰×(AVG G³⁰:G¹²⁰)×(AVG I³⁰:I¹²⁰))}

In a sample population, the results for such a calculation may be determined, and the mean, fiftieth percentile and standard deviation values examined. If, for example, the resultant values are too low to perform planned manipulations such as the adjustment in block 612, a first constant may be determined which is added to the Matsuda value to comprise the insulin resistance index. In one example, the first constant may be 1. Based on other sample data or desired fiftieth percentile, mean, or standard deviation outcomes, the constant may be adjusted. Alternatively, other means of approximating the degree of insulin resistance may be used with other embodiments of the beta cell score calculation model, for example when different laboratory tests yielding different results are used to calculate the degree of insulin resistance.

In block 608, population laboratory is used to determine an insulin release index calculation. For example, the insulin release by beta cells may be approximated by the ratio of the area under the curve (AUC) of C-Peptide levels to the AUC of Glucose levels, based on OGTT results, as described below:

$$C \text{-} PEP AUC / GLU AUC = \frac{\frac{( {C}^{0} + {C}^{30} )}{4} + \frac{( {C}^{30} + {C}^{60} )}{4} + \frac{( {C}^{60} + {C}^{120} )}{2} - ( 2 \times {C}^{0} )}{\frac{( {G}^{0} + {G}^{30} )}{4} + \frac{( {G}^{30} + {G}^{60} )}{4} + \frac{( {G}^{60} + {G}^{120} )}{2} - ( 2 \times {G}^{0} )}$$

The results from a population may be tabulated and examined. A second constant may be identified for addition to the C-Pep AUC value and a third constant identified for addition to the GLU AUC value to ensure, for example, that the resulting ratio is a positive number, while maintaining the ratio value. In some examples, the second constant may be in the range of 0-50, in some embodiments 5-20. In some examples, the third constant may be in the range of 20-80, in some embodiments 30-45. Using the second and third constant, the insulin release index may be calculated for the sample population and the fiftieth percentile, mean, and standard deviation values determined. Other standard measurements may also be taken.

In block 610, coefficients to scale insulin release index and/or insulin resistance index based on patient population data are determined. The fiftieth percentile, mean, and standard deviation values of the insulin release index and insulin resistance index may be compared. In order to avoid excessive weight being given to fluctuations in one or the other score, one or both scores may be assigned a coefficient based on the sample results to yield roughly equivalent mean and fiftieth percentile values for the scaled insulin release index and scaled insulin resistance index scores.

In block 612, a calculation to adjust the scaled insulin release index and insulin resistance index to correct for non-linearity at the extremes is created. On examination of the sample population scores, it may be determined that one or both baseline insulin resistance index and insulin release index equations produce relatively linear results near the mean, but as the upper and lower percentiles are reached, the linearity disappears. A calculation to adjust the scaled insulin release index and insulin resistance index to correct for non-linearity, such as the logarithm of the scaled insulin release index value and insulin resistance index values, may be taken. Furthermore, a coefficient may be determined for multiplying the resulting log value to set the sample adjusted insulin release value mean and adjusted insulin resistance value mean at a preferred value. In one example, the preferred value may be 100, and the coefficient chosen to yield an adjusted insulin release and adjusted insulin resistance value mean of 100.

In block 614, a calculation of the appropriateness of beta cell responsiveness is determined using population data. As insulin resistance increases, the insulin release must also increase to maintain appropriateness of the response. The adjusted insulin release and adjusted insulin resistance values as determined by block 612 are approximately equal for a patient with average metabolic function and normal glucose tolerance. However, as insulin release begins to fail with beta cell failure and/or as insulin resistance increases beyond the compensatory capacity of an individual's beta cells, a Beta Cell Responsiveness Score may begin to decrease, as the response becomes less and less appropriate. For example, using sample population data as discussed above, the adjusted insulin release value may be divided by the difference between a constant equaling twice the mean value of the adjusted insulin resistance index and the adjusted insulin resistance index.

Furthermore, the resultant quotient, which may, for example, be between 0 and 1, may be multiplied by a constant to yield a final Beta Cell Responsiveness Score. In one example, the constant may be 100, which yields a scale of 1-100. Multiplying by a larger or smaller constant will yield a different scale, which may be desired in some embodiments. Furthermore, it may be particularly useful to further simplify the reported values in order to maximize their impact and understandability. For example, it may be visually stimulating to report the beta cell calculation results in a red-yellow-green format, wherein green is normal (i.e., above 50 on a 100 point scale), yellow is at risk for developing diabetes (i.e., between 20 and 50 on a 100 point scale), and red is considered diabetic (20 or below on a 100 point scale). This is useful because the red-yellow-green format is associated with stoplights in patients' minds. In other embodiments, four or five or six states may be identified, such that low/medium/high risks are separately identified. These may be distinguished by shape or color, or may simply be labeled low, medium, and high risk (as well as normal or diabetic). Other methods of distinguishing between conditions may include type color or font. It will be apparent that any labeling system, whether verbal, visual, or a combination of the two, which increases patient recognition of their condition, attracts and maintains attention, or in any way renders the transfer of information to the patient more effective, is contemplated.

In block 616, optional functionality for a user to adjust the rules and/or patient data base or add additional rules or patient data to the current model may be provided. In some embodiments, there may be a user interface or scripting interface for altering aspects of the calculation manually, such as changing one or more constants or coefficients or adding to or substituting the sample population data and permitting the model creation engine to create a new or modify the existing model to reflect these changes. In some embodiments, the features associated with block 616 may be omitted. For example, the model creation engine may be used to generate the model only once, in some instances upon installation.

### I. Identification of at-Risk Patients for Cardiovascular Events Through Methods of Metabolic Screening

1. Clinical Correlation of Metabolic and Cardiovascular Events

Because approximately 50% of patients who suffer a first myocardial infarction are characterized as low or intermediate risk by conventional risk factor assessment, there is a pressing need for developing evaluation means which will identify these patients who are not identified by conventional assessments. Pre-diabetic patients have been shown to have a cardiovascular risk 50% greater than their non-pre-diabetic counterparts. Insulin resistance is present throughout the spectrum of conversion from pre-diabetes to diabetes and is associated with metabolic changes associated with increased endothelial cell dysfunction, dyslipidemia and inflammation. Patients with normal glucose tolerance display varying degrees of insulin resistance. Carotid intima-media thickness (C-IMT) and carotid plaques are validated indicators of risk of myocardial infarction.

Study 2

The association between the severity of insulin resistance (reflected by the Matsuda Index v. HOMA-IR) and Carotid IMT with plaque screen in patients with normal glucose tolerance was examined. 157 primary care patients at risk for diabetes based upon AACE (American Association of Clinical Endocrinologists) screening guidelines (http://www.aace.com/files/dm-guidelines-ccp.pdf Table 6) were found to have normal glucose tolerance (NGT) by ADA (American Diabetes Association) criteria (American Diabetes Association. Diagnosis and Classification of Diabetes Mellitus.” Diabetes Care 2012:35 (Suppl 1): S64-S71. Simultaneous assessments of insulin and C-peptide levels throughout the glucose tolerance test allowed the calculation of insulin sensitivity (Matsuda Index and HOMA-IR). Carotid IMT with a plaque sweep was performed in each of these patients.

Of the 157 patients assessed, 48 (31%) had a C-IMT CCA>75^{th} percentile compared to the ARIC database (+IMT Group). 81 (52%) patients demonstrated either an increased IMT, plaque or both (+IMT &/or PLQ Group). Linear regression analysis revealed an association between insulin resistance as measured by Matsuda and the presence of “+IMT” or “+IMT &/or PLQ” (p=0.007). When HOMA-IR was used to approximate insulin resistance, linear regression analysis revealed no significant association (p=0.24). When a subset of patients with NGT and a CRP level<1 were similarly analyzed (n=85), the association between abnormal IMT and/or Plaque screen and Matsuda assessed insulin resistance remained (p=0.004). HOMA-IR failed to demonstrate an association in this subgroup (p=0.07). Using data from all patients (n=157), a logistic regression equation for the probability of either an increased IMT, plaque or both based upon Matsuda Index was derived:

$$PROBABILITY = \frac{{e}^{( 0.8344 - 0.0919 \times MATSUDA )}}{1 + {e}^{( 0.8344 - 0.0919 \times MATSUDA )}}$$

Similarly, a logistic regression equation for patients with NGT and hs-CRP<1 and insulin resistance based upon Matsuda index was derived:

$$PROBABILITY = \frac{{e}^{( 1.3556 - 0.1368 \times MATSUDA )}}{1 + {e}^{( 1.3556 - 0.1368 \times MATSUDA )}}$$

Patients in a primary care practice with NGT demonstrated an association between insulin resistance determined by Matsuda Index and the presence of abnormal carotid IMT (IMT>75th percentile or either increased IMT, carotid plaque or both). This association was also present for a subset of patients with NGT and hs-CRP<1. Using HOMA-IR (which reflects primarily hepatic insulin resistance) no such associations were present. Total body insulin resistance measured by the Matsuda index is associated with validated surrogates for coronary artery disease (increase in Carotid IMT, or either increased IMT, plaque, or both), in patients with NGT as well as in patients with both NGT and an hs-CRP<1.

The study above showed an association between insulin resistance as measured by the Matsuda index and the probability of having an increased Carotid Intimal-media thickness, plaque or both. Utilizing risk stratification scales such as the red-yellow-green or normal-low-medium-high risk scales may allow presentation to patients in a manner that promotes the appreciation of their risk for cardiovascular events and maximizes patient compliance with management and evaluation regimens. It may be beneficial to report these results and others that are presented as part of the metabolic/cardiovascular workup in similar format to make interpretation as simple as possible.

Furthermore this association determined between Matsuda Index scores and probability of CIMT/plaque suggests that insulin resistance scores calculated as part of a metabolic evaluation may be used to generate recommendations for proceeding with cardiovascular workup in the presence or absence of independent risk factors as conventionally evaluated.

2. Embodiments of Expanded, Individualized Patient Reports Generated Using Beta Cell Responsiveness Scores

The invention furthermore provides for the adjustment of targets for laboratory results to reflect the contribution of metabolic risk factors related to abnormal insulin production/responsiveness to overall cardiac risk.

In some embodiments, data is retrieved from various sources. These sources may include laboratory results, diagnostic imaging results, patient demographic information input into a system, and others. Data from a Glucose Tolerance Test is then used to determine a beta cell responsiveness score. Based on the beta cell responsiveness score, the patient is classified into a group; for example, in one embodiment, the patient is classified as red, yellow, or green. A customized report is then generated for the patient, which displays his classification for beta cell responsiveness, as well as the underlying laboratory result data. Furthermore, other laboratory and/or imaging studies may be incorporated into the report to place the beta cell responsiveness into context. For example, in a comprehensive GIST (Glucose Insulin Stress Test) result report, red-yellow-green indicators may be used for muscle insulin sensitivity and oral glucose tolerance test, along with the calculated numbers. Furthermore, other laboratory results, such as those in customizable panels such as a lipid/metabolic panel, may be displayed. Bar graphs, line graphs, charts, tables, or other reporting formats may be used to track progress over time, allowing patients to equate their results to prior ones, and to measure them against the red/yellow/green standards. Furthermore, the oral glucose tolerance test results may be presented in both tabular and line graph form, or in other formats, to better show the patient his results. The diabetes relative risk categories are then shown, which are based on the pattern of response demonstrated by the patient to the OGTT. Based on the tests performed and most relevant results, appropriate summary information about normal and pathologic function of glucose metabolism may be provided, along with treatment recommendations personalized to the patient.

Other studies which may be useful adjuncts to the metabolic evaluation may include, but are not limited to, a Metabolic Biomarker Profile, Ultrasound assessment of “Fatty Liver,” Ultrasound determination of Visceral/Sub-Q/Epicardial Fat, Ultrasound assessment of Plaque Vulnerability, Ultrasound elastography of liver, Echocardiographic quantification of asymptomatic decline in heart muscle function (diastolic dysfunction), and assessment of cognitive function and memory. Furthermore, it may be useful to provide the Beta Cell Responsiveness Report in conjunction with cardiovascular reports, which may be customized based not only on the results obtained with conventional testing, but in response to the results of beta cell responsiveness evaluation and other metabolic testing. Adjunctive tests that may be performed include, but are not limited to, such tests as Carotid IMT with “Vascular Age” determination, a Plaque Vulnerability Index based on the calculated inflammatory risk (e.g., CRP, Lp-PLA2, myeloperoxidase, urinary F2 isoprostanes, urinary microalbumin, and other measurements), lipid panels (may comprise cholesterol, triglycerides, LDL, HDL, non-HDL, homocysteine, Lp(a), and others), and vascular biomarker panel. For each of these individual tests and/or panels of tests, a risk stratification may be assigned, such as the red-yellow-green light model. Sample images, absolute laboratory results, summaries of normal and abnormal anatomy and function relating to the results, and treatment recommendations may be provided, often personalized for the particular patient.

Patient demographics may be used in calculating the risk classification for a particular patient, either by absolutely changing the target numbers for the red-yellow-green or other risk classification categories, or through creation of a model which weights one or more factors to modify risk classification modules to reflect the relative risk. Furthermore, initial screening may be based on certain criteria, such as, but not limited to, any of the following: family history of diabetes, history of gestational diabetes, delivery of a baby>9 lbs., polycystic ovary syndrome, premature CAD (men<50, women<60 years), increased triglycerides and/or low HDL, previously identified IGT, IFG and/or metabolic syndrome, overweight, obese or sedentary lifestyle, hemoglobin A1c>6.0, fatty liver/NAFLD/NASH, apnea/disrupted sleep, or acanthosis nigricans.

### J. Terminology

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together. Although certain computer-implemented tasks are described as being performed by a particular entity, other embodiments are possible in which these tasks are performed by a different entity.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Terms used herein such as “optimize,” “minimize,” “maximize,” and the like may, in addition to having their ordinary meaning, can denote attempts to optimize, minimize, or maximize one or more parameters or processes while potentially not fully optimizing, minimizing, or maximizing the parameters or processes. For instance, although a parameter or process may be referred to as being “optimized” herein, the parameter or process may be improved over some prior state and not actually reach an optimal solution. Similarly, a quantity that is “minimized” or “maximized” may be reduced or increased less than a fully minimal or maximal amount, respectively.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A system for reporting diabetic risk, the system comprising:
an electronic data repository configured to store patient data regarding a plurality of patients, wherein the patient data regarding at least a portion of the plurality of patients comprises a result of a laboratory test of patient glucose tolerance;
a risk reporting component comprising one or more computing devices programmed by executable instructions to at least:
receive, from a user device via a communication network, a request for a report regarding a diabetic risk associated with a first patient of the plurality of patients;
retrieve, from the electronic data repository, first patient data regarding the first patient;
calculate an insulin release index based at least partly on the first patient data, the insulin release index indicating a correlation of an insulin release measurement associated with the first patient to a model insulin release measurement associated with a population, wherein the insulin release index is scaled to correct for non-linearity at extreme values;
calculate an insulin resistance index based at least partly on the first patient data, the insulin resistance index indicating a correlation of an insulin resistance measurement associated with the first patient to a model insulin resistance measurement associated with the population, wherein the insulin resistance index is scaled to correct for non-linearity at extreme values;
calculate a beta cell responsiveness score indicating an appropriateness of a beta cell response of the first patient to a glucose load, the beta cell responsiveness score based at least partly on a ratio of the insulin release index to the insulin resistance index;
assign, based at least partly on the beta cell responsiveness score, the first patient to a particular diabetes risk category of a plurality of diabetes risk categories, each of the plurality of diabetes risk categories associated with a different range of beta cell responsiveness scores, wherein each of the plurality of diabetes risk categories is based at least partly on a correlation of beta cell responsiveness scores with observed incidence rates of diabetes;
generate the report regarding the diabetic risk associated with the first patient, the report comprising a visual indicator of the diabetes risk category to which the first patient is assigned; and
transmit, to the user computing device, via the communication network, the report.

2. The system of claim 1, wherein the laboratory test comprises an oral glucose tolerance test.

3. The system of claim 1, wherein the plurality of diabetes risk categories comprises a high risk category, a medium risk category, and a low risk category.

4. The system of claim 1, wherein each of the plurality of diabetes risk categories is associated with a different color, and wherein at least a portion of the visual indicator displays a color associated with the diabetes risk category to which the first patient is assigned.

5. The system of claim 1, wherein the risk reporting component is further programmed to:
calculate the model insulin release measurement and the model insulin resistance measurement based at least partly on patient data obtained from the electronic data repository.

6. A computer-implemented method of generating metabolic risk reports, the computer-implemented method comprising:
obtaining patient data associated with a patient, the patient data comprising a result of a laboratory test of patient glucose tolerance;
calculating, by a reporting system comprising one or more computing devices, a first index and a second index based at least partly on the patient data,
wherein the first index is based at least partly on a correlation of an insulin release measurement associated with the patient to a model insulin release measurement associated with a population, and
wherein the second index is based at least partly on a correlation of an insulin resistance measurement associated with the patient to a model insulin resistance measurement associated with the population;
associating, with the patient, a particular risk category of a plurality of risk categories based at least partly on a ratio of the first index to the second index; and
generating a metabolic risk report comprising information regarding the particular risk category associated with the patient.

7. The computer-implemented method of claim 6, further comprising:
scaling at least one of the insulin release index and the insulin resistance index to correct for non-linearity at extreme values.

8. The computer-implemented method of claim 6, further comprising:
calculating a patient score based at least partly on a ratio of the first index to the second index, wherein associating the patient with the particular risk category is based at least partly on the patient score.

9. The computer-implemented method of claim 8, wherein each of the plurality of risk categories is associated with a different range of patient scores.

10. The computer-implemented method of claim 8, wherein each of the plurality of risk categories is based at least partly on a correlation of patient scores with observed incidence rates of diabetes.

11. The computer-implemented method of claim 10, wherein the plurality of risk categories comprises a first category associated with a high risk of diabetes, a second category associated with a moderate risk of diabetes, and a third category associated with a low risk of diabetes.

12. The computer-implemented method of claim 6, wherein the information regarding the particular risk category associated with the patient comprises a visual indicator of the particular risk category.

13. The computer-implemented method of claim 12, wherein each of the plurality of risk categories is associated with a different color, and wherein at least a portion of the visual indicator displays a color associated with the particular risk category with which the patient is associated.

14. The computer-implemented method of claim 6, further comprising:
calculating the model insulin release measurement and the model insulin resistance measurement based at least partly on patient data regarding a plurality of patients.

15. One or more non-transitory computer readable media comprising executable code that, when executed, causes one or more computing devices to perform a process comprising:
obtaining patient data associated with a patient, the patient data comprising a result of a laboratory test of patient glucose tolerance;
calculating, by a reporting system comprising one or more computing devices, a first index and a second index based at least partly on the patient data,
wherein the first index is based at least partly on a correlation of an insulin release measurement associated with the patient to a model insulin release measurement associated with a population, and
wherein the second index is based at least partly on a correlation of an insulin resistance measurement associated with the patient to a model insulin resistance measurement associated with the population;
associating, with the patient, a particular risk category of a plurality of risk categories based at least partly on a ratio of the first index to the second index; and
generating a metabolic risk report comprising information regarding the particular risk category associated with the patient.

16. The one or more non-transitory computer readable media of claim 15, wherein the process further comprises:
scaling at least one of the insulin release index and the insulin resistance index to correct for non-linearity at extreme values.

17. The one or more non-transitory computer readable media of claim 15, wherein the process further comprises:
calculating a patient score based at least partly on a ratio of the first index to the second index,
wherein each of the plurality of risk categories is based at least partly on a correlation of patient scores with observed incidence rates of diabetes,
and wherein the plurality of risk categories comprises a first category associated with a high risk of diabetes, a second category associated with a moderate risk of diabetes, and a third category associated with a low risk of diabetes.

18. The one or more non-transitory computer readable media of claim 15, wherein the information regarding the particular risk category associated with the patient comprises a visual indicator of the particular risk category.

19. The one or more non-transitory computer readable media of claim 18, wherein each of the plurality of risk categories is associated with a different color, and wherein at least a portion of the visual indicator displays a color associated with the particular risk category with which the patient is associated.

20. The one or more non-transitory computer readable media of claim 15, wherein the process further comprises:
calculating the model insulin release measurement and the model insulin resistance measurement based at least partly on patient data regarding a plurality of patients.
